(19) United States
(12) Patent Application Publication
(10) Pub. No.: US 2021/0392982 A1
(43) Pub. Date: Dec. 23, 2021

(54) Electrostatics Shield for preventing the transmissions of respiratory diseases.

(71) Applicant: Anuthep Benja-Athon, New York, NY (US)

(72) Inventor: Anuthep Benja-Athon, New York, NY (US)

(21) Appl. No.: 16/907,291

(22) Filed: Jun. 21, 2020

(51) Int. Cl. A41D 31/26; A62B 23/02; A41D 13/11

(52) U.S. Cl. CPC A41D 31/265; A41D 13/1192; A62B 23/025

(57) ABSTRACT

The electrostatics shield for attracting, capturing and binding expelled electrostatics charged aerosols in the air. The eShield guarding and shielding facial coverings and orifices and gaps between said facial coverings and faces to prevent the transmissions of respiratory diseases.

### FIELD OF THE INVENTION

The Electrostatics Shield for preventing the transmissions of respiratory diseases.

### BACKGROUND OF THE INVENTION

The effective physical barriers and practices of respiratory and oral hygiene for preventing or reducing the disseminations and transmissions of communicable diseases via oral to respiratory system are unavailable and ineffective, respectively. The present civilizations and advanced societies in nations of the world exist because of the most efficient land, air and water transports and indoor—small and crowded quarters—and outdoor gatherings of close contacts among commuters, riders and audiences such as, but not limited to, railroads, aeroplanes, vehicles, ferries and ships, stadiums and arenas, etc.

“A Cough: A single cough releases about 3,000 droplets and droplets travels at 50 miles per hour. Most droplets are large, and fall quickly (gravity), but many do stay in the air and can travel across a room in a few seconds. A Sneeze: A single sneeze releases about 30,000 droplets, with droplets traveling at up to 200 miles per hour. Most droplets are small and travel great distances (easily across a room). If a person is infected, the droplets in a single cough or sneeze may contain as many as 200,000,000 (two hundred million) virus particles which can all be dispersed into the environment around them. A breath: A single breath releases 50-5000 droplets. Most of these droplets are low velocity and fall to the ground quickly. There are even fewer droplets released through nose-breathing. Importantly, due to the lack of exhalation force with a breath, viral particles from the lower respiratory areas are not expelled.

Unlike sneezing and coughing which release huge amounts of viral material, the respiratory droplets released from breathing only contain low levels of virus.” Erin S. Bromage, Ph.D., Associate Professor of Biology at the University of Massachusetts Dartmouth.

In other words, in said settings and circumstances, the status quo rudimentary masks including N95 and surgical masks and cloth coverings, protocols, partitions and Boeing filtered cabin air provide no reliable protection against COVID 19 and other respiratory viral diseases. Said industries are losing $ billions each month with gravest tangible and intangible consequences on civilizations and billions of people.

In said settings and circumstances, the Electrostatic Shield for preventing the transmissions of respiratory diseases henceforth known as eShield is based on the basic and clinical sciences and medicine known to this pro se applicant. The facts are respiratory viruses, and the likes, comprise electronical charges and live, thrive, replicate in and spread—being transported in electronical charged biological fluids of the hosts—among electronical charges of the hosts and infected biological cells. In other words, said viruses thrive in said biochemical fluids being expelled and disseminated by coughs, sneezes, saliva aerosols, singing, etc. transmitted between and among people and animals by biochemical fluids such as, but not limited to, the respiratory and oral and gastrointestinal systems. Said biochemical fluids protecting and transmitting said viruses comprise, but not limited to, surfactant—phospholipids at the alveolar level, lung cells of the respiratory tree and saliva, comprising a complex biochemistry such as, but not limited, water, electrolytes, mucus comprises mucopolysaccharides and glycoproteins, antibacterial compounds, enzymes such as alpha-amylase, lingual lipase, kallikrein, human and bacterial cells and other proteins.

The eShield effectively addresses the matters in said quotation. Thus, the eShield renders the most effective and perfect device for breaking said cycle of disseminations and transmissions of respiratory infections among humans.

### SUMMARY OF THE INVENTION

The Electrostatics Shield for preventing the transmissions of respiratory diseases known herein as eShield. The eShield for attracting, capturing and binding expelled electrostatics charged aerosols containing respiratory viruses, among other viruses and bacterias, in the air. The electrostatic eShield guarding and shielding facial coverings and orifices and gaps between said facial coverings and faces to prevent the transmissions of respiratory diseases.

DIAGRAM OF THE INVENTION

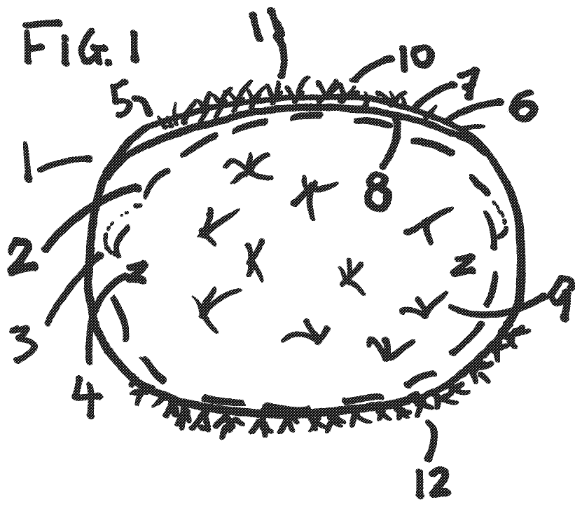

FIG. 1—The eShield for attracting, capturing and bindings oral and respiratory droplets and viruses.

### DESCRIPTION OF THE PREFERRED EMBODIMENTS

FIG. 1 is a schematics of electrostatics shield 1 juxtaposing a face mask 2—represented by a broken circle—representing said facial coverings 2 such as, but not limited to, masks, cloth coverings and plastic fascial shields 2 and elastic bands and straps, ties and/or head mounts, respectively, 3.

For eShield 1 to guard and shield said facial coverings and orifices and gaps (not shown as this defect is common and obvious to billions of people)—crucial factor in said settings and circumstances—between said facial coverings and faces to prevent electrostatics charged oral and respiratory system-produced fluids, droplets and saliva and nasal aerosols and discharges comprise said nasal- and oral-expelled electrostatics charged biochemicals- and fluids-coated viruses and free viruses collectively known herein as charged aerosols to invade human oral and respiratory systems.

The eShield 1 can be produced in small, medium, large and extra large so that eShield 1 lengths and widths approximately same asthose of facial coverings 2. The eShield 1 is attached to facial coverings 2 by a plurality of staples 4—Z—for uniting said eShield and facial coverings, chemical adhesives 4 for uniting said eShield and facial coverings and/or hook-and-loop fasteners 4 for reversibly uniting said eShield and facial coverings 2, One of the versatile applications of eShield is the fact that staples, chemical adhesives, such as, but not limited to glues and hook and loop fasteners 4 are ubiquitous in said settings including homes and circumstances. One of the preferred embodiments is eShield 1 and said means for attaching 4 are in individual packages available to people with diverse head and facial configurations and dimensions and preferences. To guard and shield said facial coverings and orifices and gaps, said individuals can use said means for attaching 4 to customize the unity and relative positions of eShields 1 and said facial coverings 2 to fit said configurations and to ensure that superior portion 5, or for that matter any portions, of eShields 1 is adjacent to or cover said orifices and gaps. The eShield 1 can be reversibly detached from said facial coverings by said users.

The eShield 1 comprises insulator base 6—any synthetic fabrics sheet and plant fiber sheet inert to electrostatics—comprises the posterior surface 7 for juxtaposing the air space anterior to and between said facial coverings and said posterior surface 7 and anterior surface 8 for supporting, attaching and exposing said electrostatic materials to attract, capture and bind said charged aerosols.

Further to supra, said anterior surface 8 comprises electrostatic materials 9, 10, 11 and 12 for guarding and shielding said facial coverings and said orifices and gaps between said facial coverings and faces. Said electrostatic materials comprise electrostatic fibers 9, 10, 11 and 12 which completely carpeting or covering the entire anterior surface 8. In other words, electrostatic fibers 9, 10, 11 and 12—11 and 12 cover the superior and inferior parts of eShield 1, respectively, of eShield 1—attached to 100% anterior surface area. The electrostatic materials 9, 10, 11 and 12 are electrostatic fibers comprise hundreds of manufactured fluffs each of which comprises hundreds of thousands of intertwined electrostatic fibrous strands of fibers. Said fluffs creat extremely large electrostatic surface areas for effectively attracting, capturing and binding said charged aerosols. The diameter of each electrostatic fibrous strand of fiber is between about 10 and 100 microns and a few centimenters in length.

Said electrostatic fibrous strands of fibers are manufactured from polyester fibers or fiberglass.

Although various preferred embodiments of the present invention have been described, it will be appreciated by and obvious to those skilled in the art and science that adaptations, variations and derivatives of said embodiments are and will be made and achieved for animals without departing from the spirit and scope of the present invention.

1. The electrostatics shield for attracting, capturing and binding expelled electrostatics charged oral and respiratory system-produced fluids, droplets and saliva and nasal aerosols and discharges comprise said nasal- and oral-expelled electrostatics charged biochemicals- and fluids-coated viruses and free viruses collectively known as charged aerosols containing respiratory viruses close to and in contact with said electrostatics shield juxtaposition with facial coverings, being anterior or anterior and lateral to said facial coverings of eyes, noses and mouths and noses and mouths henceforth known as eShield for guarding and shielding said facial coverings and orifices and gaps between said facial coverings and faces, said eShield for interposing electrostatics for attracting, capturing and binding thence preventing, reducing and repelling said aerosols from contacting said facial coverings, orifices and gaps between said facial coverings and faces and the noses and mouths posterior to said coverings, the eShield comprises:
an attaching means for juxtaposing eShield and facial coverings;
said eShield for reversibly attaching and associating with said facial coverings, said eShield for guarding and shielding said facial coverings, noses, mouths and eyes, and orifices and gaps between said facial coverings and faces;
said insulator base for juxtaposing said facial coverings, noses, mouths and eyes;
said insulator base comprises the posterior surface for juxtaposing the air space anterior to said facial coverings;
said insulator base comprises the anterior surface for supporting, attaching and exposing said electrostatic materials to said charged aerosols;
said electrostatic materials for guarding and shielding said facial coverings; and
said electrostatic materials for guarding and shielding said orifices and gaps between said facial coverings and faces.

2. The eShield according to claim 1 wherein said attaching means for juxtaposing eShield and facial coverings comprises a plurality of staples for uniting said eShield and facial coverings;
chemical adhesives for uniting said eShield and facial coverings; and
hook-and-loop fasteners for reversibly uniting said eShield and facial coverings.

3. The eShield according to claim I wherein said electrostatics shield for reversibly attaching and associating with said facial coverings comprises said electrostatic materials comprising static electrical charge for attracting, capturing and binding said charged aerosols.

4. The electrostatic materials according to claim 3 comprise electrostatic fibers comprise electrostatics for attracting, capturing and binding to the electrostatic charges in orally expelled or discharged saliva aerosols.

5. The electrostatic fibers according to claim 4 are hundreds of fluffs each of which comprises millions of electrostatic fibrous strands of fibers.

6. The electrostatic fibers according to claim 5 comprises large electrostatic surface areas for effectively attracting, capturing and binding said charged aerosols.

7. The electrostatic fibers according to claim 6 comprises large electrostatic surface areas for effectively attracting, capturing and binding said charged aerosols.

8. In the electrostatics shield for attracting, capturing and binding charged aerosols containing respiratory viruses, a method of juxtaposing eShield and facial coverings to guard and shield said facial coverings and orifices and gaps between said facial coverings and faces to prevent the transmissions of respiratory diseases through said facial coverings, said eShield being anterior or anterior and lateral to said facial coverings of eyes, noses and mouths and noses and mouths to attract, capture and bind thence prevent, reduce and repel said aerosols from contacting facial coverings, orifices and gaps between said facial coverings and faces and the noses and mouths posterior to said coverings, the method comprises the processes of:
said attaching means juxtaposing eShield and said facial coverings;
said eShield reversibly attaching and associating with said facial coverings, said eShield guarding and shielding said facial coverings, noses, mouths and eyes, and orifices and gaps between said facial coverings and faces;
said insulator base juxtaposing said facial coverings, noses, mouths and eyes;
the posterior surface of said insulator base juxtaposing the air space anterior to said facial coverings;
the anterior surface of said insulator base supporting, attaching and exposing said electrostatic materials to said charged aerosols;
said electrostatic materials guarding and shielding said facial coverings; and
said electrostatic materials guarding and shielding said orifices and gaps between said facial coverings and faces.
